(19) United States
(12) Patent Application Publication
(10) Pub. No.: US 2024/0140384 A1
(43) Pub. Date: May 2, 2024

(54) ELECTROPNEUMATIC PARKING BRAKE UNIT WITH AN EMERGENCY RELEASE

(71) Applicant: ZF CV Systems Global GmbH, Bern (CH)

(72) Inventor: Julian van Thiel, Grossburgwedel (DE)

(21) Appl. No.: 18/407,787

(22) Filed: Jan. 9, 2024

Related U.S. Application Data
(63) Continuation of application No. PCT/EP2022/066997, filed on Jun. 22, 2022.

(30) Foreign Application Priority Data
Jul. 21, 2021 (DE) 10 2021 118 896.2

(51) Int. Cl. B60T 13/38; B60T 13/66; B60T 13/68; B60T 15/04

(52) U.S. Cl. CPC B60T 13/385; B60T 13/662; B60T 13/683; B60T 15/041; B60T 2201/10

(57) ABSTRACT

An electropneumatic valve arrangement is for actuating a parking brake function of an electropneumatic brake system of a commercial vehicle, with a pilot control unit, which modulates a pilot pressure in dependence on an electronic parking brake signal, and which is configured to be self-holding, wherein the pilot pressure can bring about a modulation of a parking brake pressure at least at one spring accumulator connection or can be modulated as such. The valve arrangement also has an emergency release connection with an emergency release path for optionally inputting an emergency release pressure, which brings about the modulation of the parking brake pressure at the at least one spring accumulator connection.

### CROSS-REFERENCE TO RELATED APPLICATIONS

This application is a continuation application of international patent application PCT/EP2021/066997, filed Jun. 22, 2022, designating the United States and claiming priority from German application 10 2021 118 896.2, filed Jul. 21, 2021, and the entire content of both applications is incorporated herein by reference.

### TECHNICAL FIELD

The disclosure relates to an electropneumatic valve arrangement for actuating a parking brake function of an electropneumatic brake system of a commercial vehicle, with a pilot control unit, which modulates a pilot pressure in dependence on an electronic parking brake signal, and which is configured to be self-holding, wherein the pilot pressure can bring about a modulation of a parking brake pressure at least at one spring accumulator connection or can be modulated as such. The disclosure also relates to a method for controlling a parking brake function of a commercial vehicle with an electropneumatic brake system and to a commercial vehicle with an electronically controllable pneumatic brake system.

### BACKGROUND

Electropneumatic valve arrangements for actuating a parking brake function are used in both Europe and the US. A parking brake function of an electropneumatic brake system usually uses so-called spring-loaded brake cylinders, which are applied on the basis of a spring force and are open when supplied with air. These spring-loaded brake cylinders should therefore be supplied with air, and thus open, when the vehicle is driving, whereas they are purged of air, and thus applied, when the vehicle is parked.

A solution for supplying air to such spring-loaded brake cylinders is disclosed in DE 10 2017 005 757 A1. The solution disclosed there uses a pilot control unit and a main valve unit, wherein the pilot control unit includes an electromagnetic solenoid valve in the form of a bistable valve. In the solution disclosed there, the main valve unit is formed by a relay valve. Depending on the switching position of the electromagnetic bistable valve, a control pressure is modulated at the main valve unit, which then modulates a volume pressure for the spring-loaded brake cylinders in a corresponding manner. A solenoid valve which has two stable switching positions, in particular a stable air-supplying position and a stable air-purging position, is referred to as a bistable valve. For this purpose, by energizing a first electromagnet, an armature of the solenoid valve can be moved into a first position, so that the solenoid valve assumes the air-supplying position, and by energizing a second electromagnet, the armature of the solenoid valve can be moved into a second position, so that the solenoid valve assumes the air-purging position. If no other force acts on the armature, or it can be mechanically and/or magnetically latched in the positions, the respective switching position is stable because it can be maintained without further energizing.

By contrast, in the US so-called push-pull valves are used in the driver's cab, via which the driver can manually bring about the supplying of air or purging of air to or from the spring-loaded brake cylinders. When the push-pull valve is pressed in, a pneumatic connection is established, so that the spring-loaded brake cylinders of the towing vehicle are supplied with air and thus released. By contrast, if the driver pulls out the push-pull valve, the spring-loaded brake cylinders are purged of air and applied. A solution that already allows pneumatic switching of the push-pull valves is disclosed in US 2019/0308599.

Since the effort involved in providing pneumatic piping from the corresponding valves that implement the parking brake function, the spring-loaded brake cylinders, which are usually provided on the rear axle, as well as the driver's cab, is relatively high, there is a need to simplify this. There is also the need to improve the safety of such push-pull valves.

A further solution that provides a pneumatic bistability or self-holding and thus enables stable engagement of the parking brake even without further energization of an electromagnetic valve is disclosed in US 2020/0172073 and US 2023/0083111. The solution disclosed there uses as the main valve unit a pneumatically switchable 3/2-way valve and as the pilot control unit two electrically switchable 3/2-way valves, wherein one of the electrically switchable 3/2-way valves returns the pressure modulated by the main valve unit and modulates a pneumatic control connection of the main valve unit. This realizes pneumatic self-holding in the event that the main valve unit modulates a pneumatic pressure. If a fault occurs or if the supply supplying the main valve unit with supply pressure is pumped empty, the main valve unit also no longer modulates pressure, so that the main valve unit changes in a monostable manner to a different switching position, in which the corresponding spring accumulator connection is purged of air. Also if the corresponding compressed air supply is to be refilled, for example by a service technician or because the vehicle has power again, the parking brake is not automatically released again because the main valve unit is in the air-purging position and no pneumatic pressure is returned.

However, this solution, which is specifically intended for the US market, cannot be easily used in Europe, depending on the vehicle type. In addition, there is a need also to be able to implement further functionalities and thus provide an improved valve arrangement, as well as to be able to create synergies between individual products as far as possible.

The object is achieved in a first aspect of the disclosure in an electropneumatic valve arrangement of the type mentioned at the beginning in that an emergency release connection is provided, with an emergency release path for optionally inputting an emergency release pressure, which is provided at a pneumatic control connection of the pilot control unit and brings about the modulation of the parking brake pressure at the at least one spring accumulator connection.

The pilot control unit is configured to modulate a pilot pressure in dependence on an electronic parking brake signal, which can then either be processed by a further valve unit or modulated directly and immediately at the spring accumulator connection as parking brake pressure. The spring accumulator connection is preferably a spring accumulator connection of the electropneumatic valve arrangement. A further valve unit which can initially convert the pilot pressure may be formed for example by a main valve unit, which receives the pilot pressure and/or modulates a parking brake pressure at least at one spring accumulator connection in dependence on the pilot pressure. For this purpose, the main valve unit preferably also receives the supply pressure. Such a main valve unit may typically be formed by a relay valve. However, this is not absolutely necessary and the pilot pressure may also be modulated directly as parking brake pressure.

The pilot control unit is configured to be self-holding, that is, that, after initial activation by the electronic parking brake signal, modulates the pilot pressure permanently and stably, even if the electronic parking brake signal is no longer received. Self-holding is understood here as meaning in particular that the air-supplying position of the pilot control unit is maintained by the modulation of the pilot pressure itself. Valves that are stable in both the air-supplying position and the air-purging position, even if the signal on the basis of which the valve switches into the air-supplying or air-purging position is no longer received, are also self-holding. A distinction can be made between pneumatic self-holding and magnetic self-holding. In this arrangement that is known in principle, as described above with reference to the prior art, there is then the advantage that, if a supply pressure provided to the pilot control unit and used by it to modulate the pilot pressure ceases or drops, the pilot control unit switches to an air-purging position and purges air from the spring accumulator connection as a result of the self-holding. The pilot control unit is therefore preferably stable in the air-purging position. The pilot control unit preferably receives the supply pressure, preferably from a supply connection of the electropneumatic valve arrangement, which may be connected to one or more compressed air supplies of the brake system. However, if the pilot control unit is stable in the air-purging position, it in turn needs the electronic parking brake signal in order to modulate the pilot pressure and thus to re-activate the self-holding and be able to maintain the air-supplying position of the pilot control unit. However, in the event of a fault in the vehicle, the electropneumatic brake system and/or the electropneumatic valve arrangement, in which the electronic parking brake signal cannot be provided or not correctly, the pilot control unit can no longer be electronically switched or not correctly. A modulation of the parking brake pressure cannot take place in this case.

For this purpose, the disclosure proposes providing an emergency release connection, which can optionally be used to input an emergency release pressure, which brings about the modulation of the parking brake pressure to the at least one spring accumulator connection. The emergency release pressure is then provided in turn at a dedicated pneumatic control connection of the pilot control unit. The emergency release pressure is accordingly preferably modulated at a first pneumatic control surface of the pilot control unit. This pneumatic emergency release pressure can be used to modulate the parking brake pressure independently of providing the electronic parking brake signal, in order in this way to supply air to the spring accumulator connection and supply air to, and thus release, any spring-loaded brake cylinders connected to the spring accumulator connection. The emergency release connection thus allows an emergency release of the spring-loaded brake cylinders in order to allow the vehicle in which such an electropneumatic valve arrangement is used to be towed away, for example in a case where it has no electrical power, for example after an accident or defect. It may be provided here on the one hand that, as a result of the emergency release pressure, the pilot control unit is brought into the air-supplying position and/or that the parking brake pressure is modulated independently of the switching position of the pilot control unit at the spring accumulator connection.

Preferably, the pilot control unit is configured to be self-holding in that the pilot pressure modulated by the pilot control unit or a pressure derived from it is returned via a self-holding line and is provided at the pneumatic control connection or a further pneumatic control connection assigned to the pilot control unit. The returned pressure may also be referred to as a self-holding pressure. It may be modulated at the same pneumatic control connection at which the emergency release pressure is also modulated. However, it may also be modulated at a separately provided pneumatic control connection, which may then also be referred to as a self-holding connection. It may be modulated independently of this at the same pneumatic control surface as the emergency release pressure, or at a separately provided pneumatic control surface. Such a self-holding line may be configured as pneumatic tubing or piping, which branches off at any point between the pilot control unit and the spring accumulator connection. It may also be configured as a hole within a valve of the pilot control unit, so as to control the pilot pressure at the self-holding connection or the correspondingly assigned control surface. The self-holding connection is preferably a pneumatic connection of a valve, so that the modulation of the pilot pressure preferably as a self-holding pressure at the self-holding connection can bring about the switching or the retention of a switching position of a valve.

Preferably, in the event that the pressure applied to the pneumatic control connection and/or to the further pneumatic control connection is below a first threshold value, the pilot control unit is switched into a stable air-purging position. That is, that, as long as the pressure applied to the pneumatic control connection and/or to the further pneumatic control connection (self-holding connection) exceeds the first threshold value, the pilot control unit remains stable in the air-supplying position, so that the parking brake pressure remains modulated. However, if the pressure modulated at the pneumatic control connection and/or at the further pneumatic control connection, that is, in particular the pilot pressure, drops, for example because a supply pressure provided to the pilot control unit drops, for example as a result of a leak or another fault, the pilot control unit falls stably into the air-purging position. The spring accumulator connection remains purged of air in the air-purging position and spring-loaded brake cylinders connected to the spring accumulator connection remain applied.

The first threshold value is preferably provided in a range of 200 kPa to 400 kPa, more preferably 250 kPa to 350 kPa. These values should be below the normal value of the supply pressure. It may be provided that, if two or more pneumatic control connections are provided, the first threshold value is only assigned to the control connection acting as a self-holding connection. In the event that there are two or more control surfaces, the first threshold value may only be assigned to one control surface.

In one variant, the inputting of the emergency release pressure at the emergency release connection can bring about the modulation of the pilot pressure by the pilot control unit. Preferably, the inputting of the emergency release pressure can bring about the switching of a valve in the pilot control unit. It should be understood that it is also possible for two or more valves of the pilot control unit to be switched when the emergency release pressure is modulated. For this purpose, the emergency release pressure preferably exceeds a second threshold value, which is preferably higher than the first threshold value. This means that, as long as the emergency release pressure is below the second threshold value, the pilot pressure is not yet modulated, but if the emergency release pressure exceeds the second threshold value, the pilot pressure is switched off, for example by switching one or more valves of the pilot control unit. It may be provided that the second threshold value is only assigned to the pneumatic control connection if a further pneumatic control connection is provided for the self-holding pressure. In the event that there are two or more control surfaces, the second threshold value may only be assigned to one control surface.

The second threshold value is preferably in a range of 500 kPa to 900 kPa, preferably 600 kPa to 800 kPa.

In an embodiment, the emergency release pressure and the self-holding pressure are provided or modulated at the pneumatic control connection. Both the emergency release pressure and the self-holding pressure are accordingly modulated at the same pneumatic control connection and preferably also act on the same pneumatic control surface. This creates a particularly simple possibility for being able to modulate the pilot pressure even in the event that the vehicle has no electrical power or in the event that the pilot control unit can no longer or no longer be switched electronically or not correctly. For this purpose, the emergency release pressure preferably exceeds at least the first threshold value, but preferably the second threshold value.

It may be provided that the emergency release path enters an air-purging path of the pilot control unit. For example, it is thus conceivable and preferred that the emergency release path enters via a check valve or a double check valve into the air-purging path, in order in this way to modulate a control pressure via the air-purging path of the pilot control unit. The pilot control unit is in the air-purging position when the vehicle has no electrical power or no pressure, and the pilot control unit is connected to the air-purging. This means that, in this switching position, the emergency release pressure can be input via the air-purging path in order to modulate the pilot pressure via the pilot control unit or in this way provide the pilot control unit with a corresponding control pressure. This in turn brings about the modulation of the parking brake pressure or modulates it directly.

The pilot control unit may preferably have a self-holding valve unit and a holding valve. The self-holding valve unit may in turn be made up of one or more valves. The holding valve is preferably configured as a monostable 2/2-way valve and has an opening position and a closing position, wherein it is monostable in the opening position. The holding valve can be used to confine the pressure modulated by the pilot control unit, in order in this way for example to maintain air-supplying of the spring accumulator connection, independently of a switching position of the pilot control unit.

In one variant, the pilot control unit has an electromagnetic solenoid valve with at least one first permanent magnet, wherein the solenoid valve has the pneumatic control connection, wherein the solenoid valve can switch from an air-purging position into an air-supplying position in dependence on the emergency release pressure. The solenoid valve may additionally have the further pneumatic control connection. The emergency release pressure and/or the self-holding pressure can therefore be modulated at the solenoid valve. A solenoid valve of this type is distinguished by the at least one permanent magnet, via which two latching positions in the end positions of an armature of the solenoid valve can be obtained. Such valves are also referred to as bistable valve because the armature can remain stably in the two end positions as a result of the magnetic force. Accordingly, a solenoid valve which has two stable switching positions, in particular a stable air-supplying position and a stable air-purging position, is referred to as a bistable valve. It is also possible for two or more permanent magnets to be provided. One or two or more coils may be provided for switching the solenoid valve. If two coils are provided, by energizing a first coil, the armature of the solenoid valve, which preferably carries a permanent magnet, can be moved into a first position, so that the solenoid valve assumes the air-supplying position and, by energizing a second coil, the armature of the solenoid valve can be moved into a second position, so that the solenoid valve assumes the air-purging position. Both end positions form latching positions in which the solenoid valve is magnetically latched. If no other force acts on the armature, or it can be mechanically and/or magnetically latched in the positions, the respective switching position is stable because it can be maintained without further energizing.

In the case of solutions that use a solenoid valve in the form of a conventional bistable valve in the context of electropneumatic valve arrangements for actuating the parking brake function, there is the risk that the solenoid valve will also remain in an air-supplying position after a fault in the vehicle, as a result of the magnetic force exerted by the at least one permanent magnet. If the vehicle is stopped after a fault, and as a consequence the compressed air supply is drained, the spring-loaded brake cylinders are applied even without the solenoid valve being brought into the air-purging position. It can therefore remain in the air-supplying position as a result of its two magnetic latching positions, to be specific the air-supplying position and the air-purging position. If power is supplied to the vehicle again, and as a consequence the compressed air supply is filled or the compressed air supply is filled again in some another way, the spring-loaded brake cylinders may be supplied with air and thus released, which can lead to the vehicle rolling away unintentionally. To prevent this, it is known to bring the solenoid valve into an air-purging position after the spring-loaded brake cylinders have been supplied with air, wherein the pressure modulated by the solenoid valve is confined by another, further valve, such as for example a 2/2-way valve. If a fault then occurs, the solenoid valve is in the air-purging position and the 2/2-way valve in a de-energized state falls preferably into an open switching position, so that the spring-loaded brake cylinders are automatically and consequently purged of air. However, since the solenoid valve is stable or self-holding in the air-purging position as a result of the at least one permanent magnet, the spring-loaded brake cylinders cannot be easily supplied with air again if for example the vehicle is to be towed away, or the fault that caused the spring-loaded brake cylinders to be purged of air has been rectified. In order to bring the solenoid valve back into the air-supplying position, an electrical pulse is necessary, preferably the energizing of a coil of the solenoid valve. If this electrical pulse cannot be modulated or not correctly, a solenoid valve of the conventional type cannot be switched into the air-supplying position. This is where the pneumatic control connection comes in. The emergency release pressure and/or self-holding pressure can be modulated at this connection in order to switch or be able to switch the solenoid valve preferably from the air-purging position into the air-supplying position.

In an embodiment, the emergency release pressure is provided at the pneumatic control connection of the solenoid valve. This allows the solenoid valve to be switched into the air-supplying position, and thus the parking brake pressure to be modulated at the at least one spring accumulator connection via the emergency release pressure. Preferably, for this purpose the emergency release connection is connected to the pneumatic control connection of the solenoid valve via the emergency release path. Depending on the embodiment, it is conceivable and preferred that one or more valves are switched between the emergency release connection and the pneumatic control connection.

In an embodiment, the solenoid valve has a first solenoid valve connection, receiving the supply pressure, a second solenoid valve connection, modulating the pilot pressure, and a third solenoid valve connection, connected to an air-purging. Preferably, in an air-supplying position or first switching position of the solenoid valve, the first solenoid valve connection is connected to the second solenoid valve connection and, in an air-purging position or second switching position of the solenoid valve, the third solenoid valve connection is connected to the second solenoid valve connection. By energizing at least one coil, the solenoid valve can optionally be switched into the air-supplying position or the air-purging position, wherein the solenoid valve can be held magnetically in the respective switching position via the at least one permanent magnet.

It is preferably also provided that, in the event that the self-holding pressure modulated at the pneumatic control connection and/or at the further pneumatic control connection of the solenoid valve is below a or the first threshold value, the solenoid valve is switched into the air-purging position independently of a previous switching position. This ensures that the solenoid valve is in the air-purging position also in a de-energized state and also in the event of a fault and that restoring a supply pressure does not directly lead to the release of spring-loaded brake cylinders. The solenoid valve may in principle have a coil and a permanent magnet, which is then preferably arranged in the armature of the solenoid valve. The armature and permanent magnet can be moved in one or the other direction via correspondingly energizing the one coil, wherein, when bearing against a corresponding valve seat, the armature is magnetically latched there, so that the solenoid valve has two magnetic latching positions. In variants, it is also possible however for two coils and one permanent magnet, two coils and two permanent magnets or one coil and two permanent magnets to be provided. If two permanent magnets are used, they are preferably attached to a valve housing and in each case act on the armature, so that they in turn magnetically hold, and thus latch, the armature in its end positions. It is also possible for more than two coils and permanent magnets to be provided in each case.

It is also preferred that, in the event that the self-holding pressure and/or the emergency release pressure exceeds the first threshold value, the solenoid valve is held in the previous switching position, and preferably by energizing the at least one coil can optionally be switched into the air-supplying position or air-purging position. It is therefore preferably provided that, when the self-holding pressure and/or the emergency release pressure exceeds the first threshold value, the solenoid valve can be held in the air-supplying or air-purging position, depending on into which of these positions the solenoid valve has been electromagnetically switched. However, it may also be provided that the solenoid valve is switched into the air-supplying switching position.

Preferably, in the event that the self-holding pressure and/or the emergency release pressure exceeds a or the second threshold value, which is preferably higher than the first threshold value, the solenoid valve is switched into the air-supplying position. Preferably, the solenoid valve can in this case be switched into the air-purging position by energizing the at least one coil. If the self-holding pressure and/or the emergency release pressure exceeds the second threshold value, this may not only bring about the effect that the solenoid valve remains in the switching position, but also the effect that the solenoid valve is actively switched into the air-supplying position. For this purpose, the force exerted by the self-holding pressure and/or emergency release pressure preferably exceeds a magnetic holding force or latching torque applied by the at least one permanent magnet. Nevertheless, it is preferably provided that, by energizing the at least one coil, the solenoid valve can be switched into the air-purging position. When the coil is energized, an additional force is exerted on the armature, which in turn may exceed the force exerted by the self-holding pressure and/or emergency release pressure, so that the armature is moved into the other switching position. By energizing the at least one coil, the modulation of the self-holding pressure and/or emergency release pressure can thus be taken above the second threshold value in order to enforce that the air-purging position is assumed.

It can also be preferred that the solenoid valve has a preferred position. This means that the solenoid valve is preferably preloaded into one of the first and second switching positions, preferably the air-purging position. Preferably, in the preferred position the pilot control unit is connected to the air-purging. It may be provided that the modulation of the safety control pressure above the first threshold value cancels the preferred position. As soon as the self-holding pressure and/or emergency release pressure exceeds the first threshold value, the solenoid valve preferably no longer has a preferred position. However, if the self-holding pressure and/or emergency release pressure is below the first threshold value, the solenoid valve has the preferred position and switches into the preferred position in the de-energized state, to be specific preferably into the air-purging position. The preferred position may be realized for example by spring loading of the solenoid valve into the preferred position. This ensures that the solenoid valve is mechanically loaded into the preferred position and that it is moved into this preferred position when the self-holding pressure and/or emergency release pressure is below the threshold. In this case, the self-holding pressure and/or emergency release pressure thus counteracts the spring force. In the preferred position, the pilot control unit is preferably connected to the air-purging.

In a further embodiment, a pressure modulated by the solenoid valve or a pressure derived from it at the solenoid valve control connection is modulated as a self-holding pressure. This ensures that self-holding is achieved, in particular in the event that the solenoid valve has a preferred position. The preferred position is used to make the solenoid valve assume the preferred position, which is preferably the air-purging position, even in the event of a fault occurring before the solenoid valve can be electronically returned to the air-purging position. However, in order to prevent this preferred position being assumed in normal driving operation, a pressure modulated by the solenoid valve is preferably returned and provided as a self-holding pressure at the pneumatic control connection or further pneumatic control connection.

According to this embodiment, therefore, the switching position of the solenoid valve is not only made dependent on the electromagnetically set switching position and/or the preferred position, but also on the modulation of the self-holding pressure, that is, on the pressure modulated by the solenoid valve. This provides a further layer of security. It is preferably provided that, as soon as the self-holding pressure drops below the first predetermined threshold value, the solenoid valve is moved into an air-purging position independently of electromagnetic switching signals and/or its previous switching position. This can be performed pneumatically, mechanically or in some other way. Preferably, this is performed independently of an energizing power supply.

For example, a return line or a return hole, which provides the pressure modulated by the solenoid valve as a self-holding pressure at the pneumatic control connection or further pneumatic control connection, may be provided directly at a connection of the solenoid valve. However, it may also be provided that a return line branches off directly before the main valve unit, or else only downstream of it, for example before or at the spring accumulator connection. The parking brake pressure is a derived pressure modulated by the solenoid valve.

In a further embodiment, the pilot control unit is preferably configured without a solenoid valve and instead uses conventional, preferably monostable, valves. For this purpose, the pilot control unit preferably has an inlet valve and an outlet valve, which are electrically switchable and can be switched between a stable state and an activated state. The pilot control unit preferably also has a pilot valve with a or the pneumatic control connection, which receives the supply pressure and switches between a stable state and an activated state in response to a first control pressure, which is provided by the inlet valve and/or the outlet valve at the pneumatic control connection, wherein, in the activated state, the pilot valve modulates the pilot pressure. In this case, the pneumatic control connection preferably also acts as a self-holding connection. The pilot valve may accordingly have, depending on the embodiment, three pneumatic control connections, one for receiving the pressure from the inlet and/or outlet valve, one for receiving the self-holding pressure and one for receiving the emergency release pressure.

In principle, the inlet and outlet valves may also be configured as one valve unit, so that, even if the terms inlet valve and outlet valve are used, two different assemblies do not necessarily have to be used.

Such an embodiment dispenses with a solenoid valve with a permanent magnet, whereby under certain circumstances a smaller space requirement can be achieved as a result of smaller installation space sizes of the conventional valves. In addition, this can simplify the activation.

According to this embodiment, it is preferably provided that the emergency release path for modulating the emergency release pressure is connected to the pilot valve to cause the latter to modulate the pilot pressure. Efficient interconnection is achieved by the emergency release pressure acting on the pilot valve. The pilot valve acts as a kind of main valve of the pilot control unit and switches as a result of a first control pressure, which is provided by the inlet and/or outlet valve. In this case, the inlet and/or outlet valve thus do not have to be switched first to activate the pilot valve, but rather the pilot valve is caused to modulate the pilot pressure on the basis of the emergency release pressure. The first control pressure and the emergency release pressure may be provided at the same pneumatic control connection or at two separate pneumatic control connections of the pilot valve.

In one variant, for this purpose the emergency release path for modulating the emergency release pressure is connected to the pneumatic control connection of the pilot valve. For example, in the event that the inlet and/or outlet valve cannot be switched or not correctly, for example because an electronic control unit that controls these valves has failed, the pilot valve can in this way be switched by modulation of the emergency release pressure at the pneumatic control connection in order to in turn modulate the pilot pressure, which is then either provided directly as parking brake pressure or is initially supplied to a main valve unit of the electropneumatic valve arrangement.

In an alternative to this, the emergency release path enters an air-purging path of the pilot valve. If the pilot valve is in the non-activated position but in the stable position as a result of a lack of electrical energization of the inlet and/or outlet valve, it is preferably in the air-purging position. In the air-purging position, the pilot valve preferably connects a spring accumulator connection to an air-purging or the corresponding control connection of the main valve unit to an air-purging. This means that the air-purging path of the pilot valve can then be used for modulating the emergency release pressure via the pilot valve, either directly as spring-loaded brake pressure or as control pressure for the main valve unit. This embodiment accordingly makes use of the fact that, in a de-energized state, the pilot valve is always in the air-purging position and the air-purging path is consequently free. If a self-holding line, which returns the pressure modulated by the pilot valve and modulates it at a pneumatic control connection of the pilot valve acting as a self-holding connection, is additionally provided, switching of the pilot valve can also be achieved by the modulation of the emergency release pressure.

It can also be preferred that the electropneumatic valve arrangement has a main valve unit, which receives the pilot pressure and modulates the parking brake pressure at the at least one spring accumulator connection in dependence on the pilot pressure. The main valve unit preferably increases the volume of the pilot pressure and then modulates it with increased volume as the parking brake pressure. For this purpose, the main valve unit may have a relay valve which has a relay valve control connection at which the pilot pressure is modulated. In this way, the pilot pressure to be modulated by the pilot control unit can be kept low, which improves the dynamics of the system and allows air volume losses to be kept to a minimum.

It can also be preferred that the electropneumatic valve arrangement is integrated in a module, which preferably has one or more supply connections, the spring accumulator connection, an air-purging and an emergency release connection. Such a module may be configured in particular as a parking brake module. Preferably, such a module has its own electronic control unit, which can receive one or more signals of a higher-level control unit, for example via a vehicle BUS, some other BUS or direct wiring. The electronic control unit of the module can then output one or more switching signals to the electromagnetically switchable valve or valves to bring about a switching. However, it may also be provided that the individual electromagnetic valves of the electropneumatic valve arrangement are switched via a direct signal modulation of a higher-level control unit. A higher-level control unit may be in particular a central processing unit, a vehicle control unit or the like.

In a second aspect, the object mentioned at the beginning is achieved by a method for controlling a parking brake function of a commercial vehicle with an electropneumatic brake system and preferably an electropneumatic valve arrangement according to one of the embodiments described above of an electropneumatic valve arrangement according to the first aspect of the disclosure, wherein the method includes the steps of: electromagnetically switching at least one valve of a pilot control unit into an air-supplying position for modulating a pilot pressure and, as a consequence: modulating a parking brake pressure at least at one spring accumulator connection for supplying air to at least one spring-loaded brake cylinder; confining the modulated pilot pressure and/or holding the at least one valve in the air-purging position; and, when a supply pressure provided to the pilot control unit drops below a first threshold value: air-purging the pilot pressure. The method also preferably includes the step of: inputting an emergency release pressure at an emergency release connection to bring about the modulation of the parking brake pressure for releasing the at least one spring-loaded brake cylinder.

It should be understood that the electropneumatic valve arrangement according to the first aspect of the disclosure and the method according to the second aspect of the disclosure have the same and similar sub-aspects. In this respect, reference is made to the above description of the first aspect of the disclosure in full. The air-purging of the pilot pressure when a supply pressure provided to the pilot control unit drops below a first threshold value can on the one hand take place purely electrically, by a corresponding valve being switched electrically or by the electrical switching signal for the corresponding valve no longer being received, for example because an electronic control unit has a fault, or else pneumatically, by pneumatic self-holding no longer being sustainable as a result of the dropping supply pressure.

In an embodiment, the method includes the step of: modulating a self-holding pressure at a pneumatic control connection assigned to the pilot control unit for self-holding the pilot control unit in an air-supplying position, so that the pilot pressure remains modulated independently of electrical signals. It should be understood that modulation independently of electrical signals means that, even if an electrical signal of the corresponding valve is no longer received, the pilot pressure remains modulated. In other words, in the event that the pilot control unit has the solenoid valve described above with a preferred position, the air-supplying position of the solenoid valve can be maintained even if the at least one coil is no longer energized, to be specific when the self-holding pressure is modulated at the pneumatic control connection. In the event that, as described above, the pilot control unit includes the monostable inlet valve and the monostable outlet valve, as well as a pneumatically switchable pilot valve, the pilot pressure remains modulated even if neither the inlet valve nor the outlet valve is energized. The modulation of the first control pressure to hold the pilot valve in the activated position then takes place solely on the basis of the modulated self-holding pressure provided to a pneumatic control connection. Also in these cases, however, by corresponding switching of further valves, or, for example in the case of the solenoid valve, by overmodulation of the self-holding pressure, an air-purging position, in which the pilot pressure is then no longer modulated, can be assumed.

It can also be preferred that the inputting of the emergency release pressure brings about the modulation of the pilot pressure by the pilot control unit. This can take place for example, as described above, by the emergency release pressure being input via the emergency release path into an air-purging path of the pilot control unit. It can also be implemented by an emergency release pressure being provided at the or a pneumatic control connection of the pilot control unit in order in this way to switch a valve or to hold a valve in an air-supplying position.

In a third aspect, the disclosure achieves the object mentioned at the beginning by a commercial vehicle with an electronically controllable pneumatic brake system, which has an electropneumatic valve arrangement according to one of the embodiments described above of an electropneumatic valve arrangement according to the first aspect of the disclosure. Preferably, the commercial vehicle is configured to carry out the method according to the second aspect of the disclosure at least partially.

It should be understood that the electropneumatic valve arrangement according to the first aspect of the disclosure, the method according to the second aspect of the disclosure and the commercial vehicle according to the third aspect of the disclosure have the same and similar sub-aspects. In this respect, reference is made to the above description in full. The electropneumatic valve arrangement according to the first aspect of the disclosure can be implemented in the commercial vehicle according to the third aspect of the disclosure in particular in the form of a parking brake module.

### BRIEF DESCRIPTION OF DRAWINGS

The invention will now be described with reference to the drawings wherein:

FIG. 1 shows a first embodiment of an electropneumatic valve arrangement;

FIG. 2 shows a second embodiment of an electropneumatic valve arrangement;

FIG. 3 shows a third embodiment of an electropneumatic valve arrangement;

FIG. 4 shows a fourth embodiment of an electropneumatic valve arrangement;

FIG. 5 shows a fifth embodiment of an electropneumatic valve arrangement; and,

FIG. 6 shows a commercial vehicle.

### DETAILED DESCRIPTION

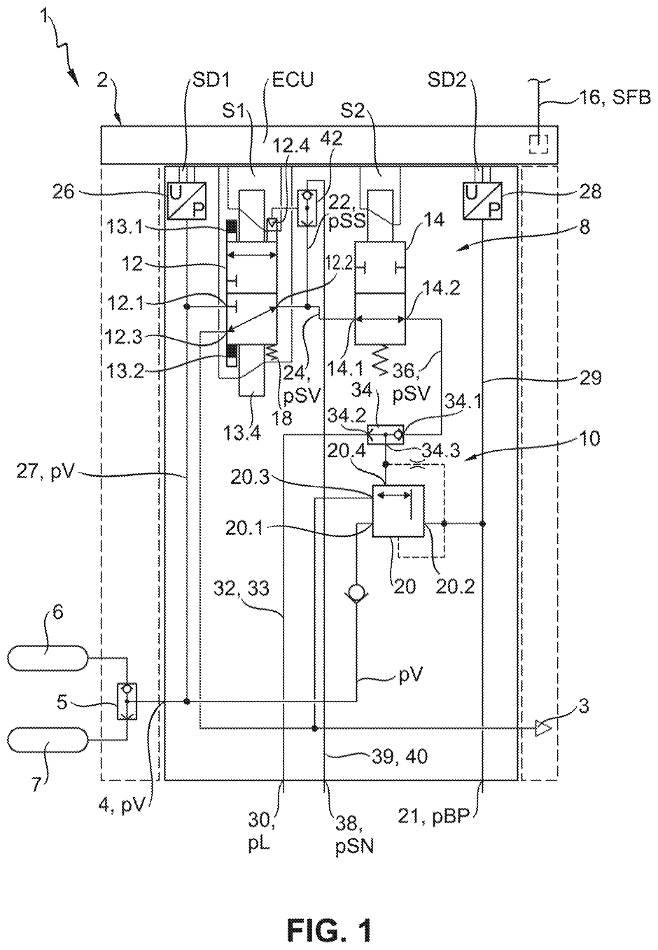

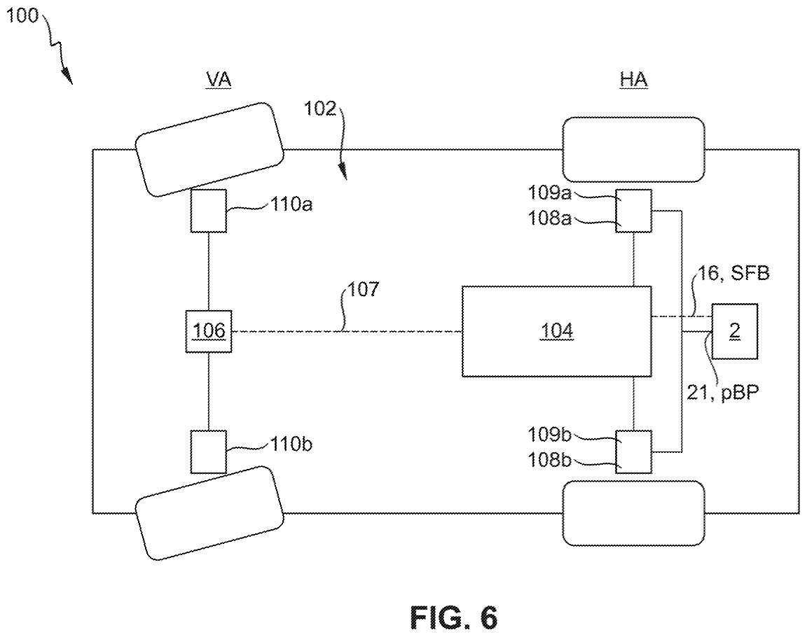

An electropneumatic valve arrangement 1 is configured in the embodiment shown in FIGS. 1 to 5 as a parking brake module 2, though this is not absolutely necessary and the electropneumatic valve arrangement 1 may rather also be integrated with other units and/or the individual valves described below may also be arranged separately and/or distributed in a brake system 102 (see FIG. 6).

The parking brake module 2 has a supply connection 4, to which a first compressed air supply 6 and a second compressed air supply 7 are connected via a supply shuttle valve 5, each providing a supply pressure pV, so that the supply pressure pV is applied to the supply connection 4. It is not absolutely necessary that two compressed air supplies 6, 7 are connected to the supply connection 4; rather, it may also be sufficient if only one compressed air supply is connected there, or the supply connection 4 is supplied via a further module.

The electropneumatic valve arrangement 1 has a pilot control unit 8 and a main valve unit 10. In the embodiment shown in FIG. 1, the pilot control unit 8 has an electromagnetic solenoid valve 12. The solenoid valve 12 has a first solenoid valve connection 12.1, a second solenoid valve connection 12.3 and a third solenoid valve connection 12.3. The first solenoid valve connection 12.1 is connected to the supply connection 4 and receives supply pressure pV. The second solenoid valve connection 12.2 is connected to the main valve unit 10, in the embodiment shown in FIG. 1 via a holding valve 14. The third solenoid valve connection 12.3 is connected to an air-purging 3. The solenoid valve 12 has a first switching position, not shown in FIG. 1, in which the first solenoid valve connection 12.1 is connected to the second solenoid valve connection 12.2. In the second switching position shown in FIG. 1, the third solenoid valve connection 12.3 is connected to the second solenoid valve connection 12.2. In this respect, the first switching position may also be referred to as the air-supplying position and the second switching position as the air-purging position. In the air-supplying position, a pilot pressure pSV is modulated via the solenoid valve 12. The solenoid valve 12 is switched in dependence on a parking brake signal SFB, which is received from the parking brake module 2, for example via a vehicle BUS 16, or may also be provided directly at the solenoid valve 12.

In this embodiment, the solenoid valve 12 has a first permanent magnet 13.1 and a second permanent magnet 13.2. In addition, in the embodiment shown the solenoid valve 12 also has a first coil 13.3 and a second coil 13.4. In dependence on the parking brake signal SFB, either the first coil 13.3 or the second coil 13.3 is energized. If the first coil 13.3 is energized, an armature of the solenoid valve 12 is attracted in a manner known in principle and so the solenoid valve 12 is switched into the air-supplying position. The armature is then held by the first permanent magnet 13.1 in the air-supplying position, which is accordingly a magnetic latching position. The first permanent magnet 13.1 and the first coil 13.3 are assigned to the air-supplying position. If, by contrast, the second coil 13.4 is energized, the armature is pulled into the opposite latching position and the solenoid valve 12 is switched into the air-purging position. In this latching position, the armature is held by the second permanent magnet 13.2. In principle, however, only one coil 13.3, 13.4 could also be provided, which is then to be reversed in its polarity to switch the solenoid valve 12 to the air-supplying position and the air-purging position. It is also conceivable that only a permanent magnet 13.1, 13.2 is provided, which is then preferably arranged on the armature of the solenoid valve 12.

In the embodiment shown in FIG. 1, the parking brake module 2 is equipped with its own electronic control unit ECU, even if this is not mandatory, and receives the parking brake signal SFB and then as a result modulates at least one first switching signal 51 at the solenoid valve 12 in order to selectively switch it between the air-supplying position and the air-purging position. In the event that the parking brake module 2 does not have its own electronic control unit ECU, the first switching signal 51 may also be provided directly by an external control unit. The solenoid valve 12 can be switched into the air-supplying position and the air-purging position respectively by a pulse. In the embodiment shown, the solenoid valve 12 in addition to conventional solenoid valves has a preferred position, to be specific the solenoid valve 12 is preloaded into the second air-purging position shown in FIG. 1. For this purpose, a spring 18 is provided, which brings the solenoid valve 12 into the second switch position shown in FIG. 1 (air-purging position).

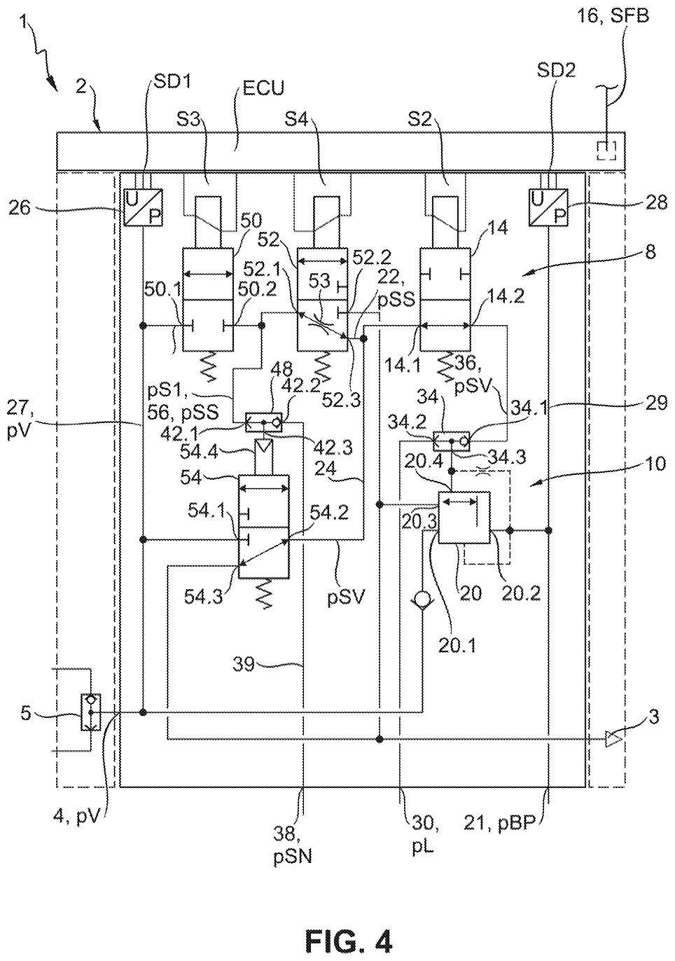

In the embodiment shown here, the pilot pressure pSV modulated by the solenoid valve 12 is provided via the holding valve 14 at the main valve unit 10. The main valve unit 10 includes a relay valve 20, which has a relay valve supply connection 20.1, a relay valve working connection 20.2, a relay valve air-purging connection 20.3 and a relay valve control connection 20.4. The relay valve supply connection 20.1 is connected to the supply connection 4 and receives supply pressure pV. The relay valve working connection 20.2 is connected to a spring accumulator connection 21 of the parking brake module 2, at which the main valve unit 10 modulates a parking brake pressure pBP. The relay valve air-purging connection 20.3 is connected to the air-purging 3, and the relay valve control connection 20.4 is connected to the pilot control unit 8 and receives the pilot pressure pSV. One or more spring-loaded brake cylinders 108a, 108b (cf. FIG. 4), which release when they are supplied with air and are applied via a spring force when they are purged of air, may be connected to the spring accumulator connection 21.

Even if all the embodiments shown here use a main valve unit 10, there may also be embodiments in which the modulated pilot pressure pSV is modulated directly at the spring accumulator connection 21, and which in this respect do not include a main valve unit 10.

In order to release the spring-loaded brake cylinders 108a, 108b, the spring accumulator connection 21 must therefore be supplied with air, so that the parking brake pressure pBP is modulated. For this purpose, the solenoid valve 12 is moved from the air-purging position shown in FIG. 1 into the air-supplying position, not shown in FIG. 1, so that the pilot pressure pSV is modulated. The holding valve 14 is in the open switching position. The holding valve 14 has a first holding valve connection 14.1 and a second holding valve connection 14.2, wherein the first holding valve connection 14.1 is connected to the solenoid valve 12, more precisely to the second solenoid valve connection 12.2, and receives the pilot pressure pSV. The second holding valve connection 14.2 is connected to the main valve unit 10, more specifically to the relay valve control connection 20.4. The holding valve 14 is configured to be electromagnetic and monostable and can be brought from the stable first switching position shown in FIG. 1, which is an opening position, into a second closed, non-stable switching position, or activated switching position, by providing a second switching signal S2 by energizing an electromagnet in the holding valve 14. If the solenoid valve 12 is thus first switched so that the pilot pressure pSV is modulated and the holding valve 14 is open, the pilot pressure pSV is passed on and modulated at the relay valve control connection 20.2, which then as a consequence increases this pressure with increased volume and modulates the parking brake pressure pBP at the spring accumulator connection 21. Then the holding valve 14 can be moved into the closed second switching position, so that the pilot pressure pSV is confined between the second holding valve connection 14.2 and the relay valve control connection 20.4. The solenoid valve 12 can then be brought back to the first air-purging position shown in FIG. 1. The spring-loaded brake cylinders 108a, 108b nevertheless still remain supplied with air and thus released. Even if only a variant with pilot control unit 8 and main valve unit 10 is described here, it should be understood that the main valve unit 10 is not absolutely necessary and the pilot pressure pSV could similarly be modulated directly as the parking brake pressure pBP. In this case, the second holding valve connection 14.2 would be connected to the spring accumulator connection 21 without intermediate connection of the main valve unit 10.

As another control mechanism, the holding valve 14 may however also remain open in its stable switching position. In order then to hold the solenoid valve 12 in the first air-supplying position, not shown in FIG. 1, the solenoid valve 12 has a pneumatic control connection 12.4, which is assigned to the pilot control unit 8. The pneumatic control connection 12.4 is connected via a self-holding line 22 to a first control line 24, which connects the second solenoid valve connection 12.2 and the first holding valve connection 14.1. The self-holding line 22 thus returns the pressure modulated by the solenoid valve 12 to the pneumatic control connection 12.4. If the pilot pressure pSV is modulated by the solenoid valve 12, it is provided via the self-holding line 22 to the pneumatic control connection 12.4, so that it is applied as a self-holding pressure pSS to the solenoid valve 12. The pneumatic control connection 12.4 is arranged so that the self-holding pressure pSS acts on the solenoid valve 12, more precisely on a pneumatic control surface not shown here, so that the solenoid valve 12 is loaded into the first switching position, not shown in FIG. 1, that is, the air-supplying position. In particular, internal control surfaces are chosen such that the self-holding pressure pSS exerts approximately a force effect matching the spring 18, so that the preferred position of the solenoid valve 12 can be canceled or neutralized by applying the self-holding pressure pSS. In this state, the solenoid valve 12 can also be switched into the air-supplying or air-purging position by corresponding energization of the first and second coils 13.3, 13.4, because the spring 18 and the self-holding pressure pSS substantially neutralize each other. In the respective switching positions, the magnetic force of either the first or second permanent magnet 13.1, 13.2 then acts, so that the switching positions are latching positions, and the armature can only be brought from the respective latching positions by overcoming the magnetic forces by applying a certain minimum force.

However, if the self-holding pressure pSS drops below a first threshold value, which may for instance lie in a range of 200 kPa to 400 kPa, the force effect by the self-holding pressure pSS is lower than that of the spring force by the spring 18, so that the solenoid valve 12 has a preferred position again and falls back into the second air-purging position shown in FIG. 1. Thus, if, in the event of a fault in the commercial vehicle 100, the supply pressure pV drops because both the first and the second compressed air supply 6, 7 are emptied, have a leak or are actively pumped down by the driver, the pilot pressure pSV also drops when the solenoid valve 12 is in the air-supplying position, not shown in FIG. 1. However, if the pilot pressure pSV drops, the self-holding pressure pSS also drops at the same time, so that, from a certain point, to be specific preferably when it falls below the first threshold value, the preferred position of the solenoid valve 12 engages again and the spring 18 brings the solenoid valve 12 into the air-purging position shown in FIG. 1, so that, as a consequence of this, the relay valve control connection 20.4 is purged of air and the parking brake pressure pBP is no longer modulated. The spring-loaded brake cylinders 108a, 108b are purged of air completely.

If, in this state, the first and/or second compressed air supply 6, 7 should be refilled, for example because the commercial vehicle 100 has energy again or the first and second compressed air supplies 6, 7 are filled by a service technician, the solenoid valve 12 is nevertheless in the second air-purging position shown in FIG. 1 and the spring accumulator connection 21 is not automatically and unintentionally supplied with air. Only by providing the parking brake signal SFB or first switching signal S1 and energizing the first coil 13.3 can the solenoid valve 12 be brought back into the air-supplying position, not shown in FIG. 1, for supplying air, so that the spring-loaded brake cylinders 108a, 108b can be released again. Unintentional release of the spring-loaded brake cylinders 108a, 108b is effectively prevented.

In the embodiment shown here (FIG. 1), the parking brake module 2 also has a first pressure sensor 26 and a second pressure sensor 28. The first pressure sensor 26 is connected to the supply connection 4 via a first pressure measuring line 27 and thus measures the supply pressure pV and provides a corresponding first pressure signal SD1 at the electronic control unit ECU. The second pressure sensor 28 is connected to the spring accumulator connection 21 via a second pressure measuring line 29 and thus determines the parking brake pressure pBP and provides a corresponding second pressure signal SD2 at the electronic control unit ECU. The first and second pressure signals SD1, SD2 can be used to verify and check the plausibility of the modulation of the pressures and the switching position of the individual valves.

The electropneumatic valve arrangement 1 also has a release control connection 30. Such a release control connection 30, via which a release control pressure pL can be input, is also referred to as an anti-compound connection. The release control connection 30 is connected to a release control path 32. The release control pressure pL input via the release control connection 30 brings about the modulation of the parking brake pressure pBP at the at least one spring accumulator connection 21. The release control path 32 includes a release line 33, which extends from the release control connection 30. The release control pressure pL used is typically the pressure of a further axle, for example the front or rear axle, in particular the service brake pressure. In the event that the spring-loaded brake cylinders 108a, 108b connected to the spring accumulator connection 21 are also used for auxiliary braking or emergency braking, this is intended to prevent excessive actuation of the spring-loaded brake cylinders 108a, 108b, which could lead to locking of the vehicle 100. So, if service brakes are activated on the rear axle, as far as possible the spring-loaded brake cylinders 108a, 108b should not be engaged at the same time either, so that it is advisable to provide the service brake pressure of the rear axle as release control pressure pL to the release control connection 30 in order to release the spring-loaded brake cylinders 108a, 108b conversely to engage the service brakes.

In the embodiment shown in FIG. 1, the release control line 33 is connected to a shuttle valve 34. The release control pressure pL can be supplied to the relay valve control connection 20.4 via the release control path 32. The shuttle valve 34 has a first shuttle valve connection 34.1, a second shuttle valve connection 34.2 and a third shuttle valve connection 34.3. The shuttle valve 34 is configured so that it passes on in each case the higher of the pressure of the pressure applied to the first and second shuttle valve connections 34.1, 34.2 to the third shuttle valve connection 34.3. The first shuttle valve connection 34.1 is connected here to the second holding valve connection 14.2 via a second control line 36, but may also be connected directly to the second holding valve connection 14.2 or else to the solenoid valve 12. In any case, the first shuttle valve connection 34.1 is connected to the pilot control unit 8 and receives the pilot pressure pSV. The second shuttle valve connection 34.2 is connected to the release control connection 30 and receives the release control pressure pL. The third shuttle valve connection 34.3 is connected to the relay valve control connection 20.4, so that in each case the higher of the pilot pressure pSV or the release control pressure pL is modulated to the relay valve control connection 20.4, in order thus to bring about the modulation of the parking brake pressure pBP.

The electropneumatic valve arrangement 1 also has an emergency release connection 38, via which an emergency release pressure pSN can be supplied. In this embodiment, the emergency release connection 38 is connected via an emergency release path 39 to the pilot control unit 8, to be specific the solenoid valve 12, more precisely to the pneumatic control connection 12.4, and can provide the emergency release pressure pSN at the pneumatic control connection 12.4. For this purpose, an emergency release shuttle valve 42, which is connected to the emergency release connection 38 via an emergency release line 40, is switched between the self-holding line 22 and the pneumatic control connection 12.4. Like the first shuttle valve 34, the emergency release shuttle valve 42 is configured so that in each case the higher of the self-holding pressure pSS or emergency release pressure pSN is modulated at the pneumatic control connection 12.4. In this way, the solenoid valve 12 can be moved from the first switching position shown in FIG. 1 to the second air-supplying position, not shown in FIG. 1, in particular when the emergency release pressure pSN exceeds a second threshold value, which preferably lies in a range of 400 kPa to 800 kPa and exceeds the force applied by the spring 18 and optionally a latching force for the armature of the solenoid valve 12, which holds it in the air-purging position, so that the solenoid valve 12 can switch over. In this way, the supply pressure pV can then be provided to the pilot control unit 8 in order in this way to modulate the pilot pressure pSV and consequently to supply air to the spring accumulator connection 21.

In the embodiment shown in FIG. 1, the emergency release pressure pSN and the self-holding pressure pSS are thus modulated at the same pneumatic control connection, to be specific the pneumatic control connection 12.4. In embodiments not shown here, only the emergency release pressure pSN is modulated at the pneumatic control connection, while the self-holding pressure pSS is modulated at a further pneumatic control connection not shown here, which is provided separately from the pneumatic control connection 12.4. In this case, the emergency release shuttle valve 42 may then also be omitted.

The emergency release pressure pSN is used in particular to switch the solenoid valve 12 in the event that the switching signal S1 cannot be provided. For example, the emergency release pressure pSN may be a manually modulated pressure supplied via an externally connected container, such as for example a tire pressure. However, the pressure of a further compressed air supply, a further module, a further axle or the like, not shown here, may also be used. The emergency release pressure pSN is used in particular to supply air to the spring accumulator connection 21 in the event that the pilot control unit 8, in this case the solenoid valve 12, can no longer be electronically switched into the air-supplying position. For example, the solenoid valve 12 could in this way be reset by the service brake pressure of a further axle.

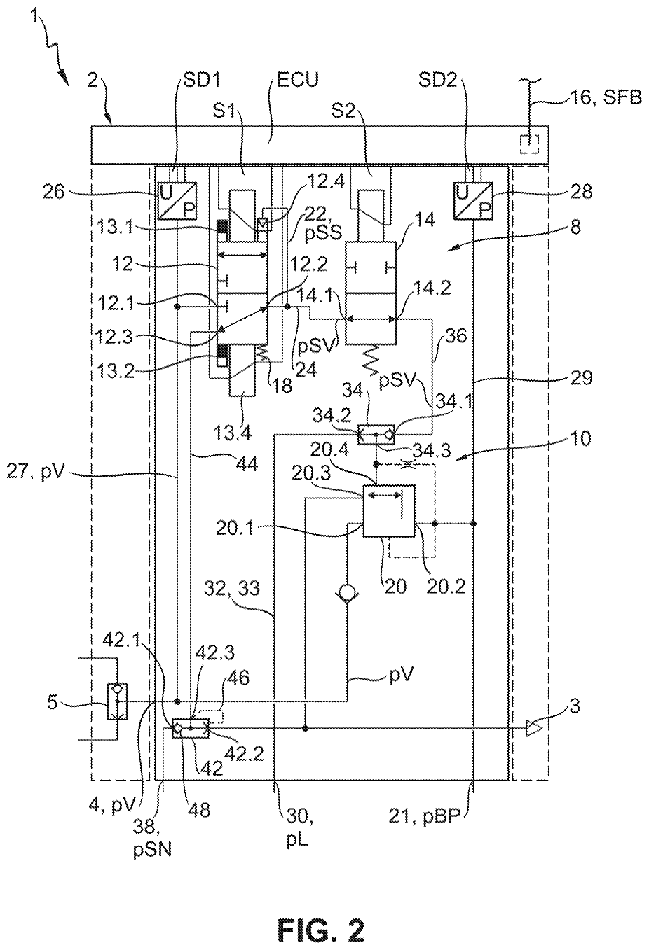

A variant of this is shown in FIG. 2. FIG. 2 is based on FIG. 1, and identical and similar elements are provided with the same reference numerals, so that reference is made to the above description of the first embodiment (FIG. 1) in full. In the following, the differences from the first embodiment are highlighted in particular.

As a difference from the first embodiment (FIG. 1), the emergency release connection 38 is not directly connected to the pneumatic control connection 12.4 of the solenoid valve 12, but rather first enters an air-purging path 44 of the pilot control unit 8, in the embodiment shown here of the solenoid valve 12. Via the emergency release connection 38, the emergency release pressure pSN can first be modulated here via the air-purging path 44 at the third solenoid valve connection 12.3, so that when the solenoid valve 12 is in the air-purging position, on the one hand this connection in turn causes the modulation of the pilot pressure pSV, and on the other hand modulation also takes place via the self-holding line 22 at the pneumatic control connection 12.4, which then has the effect that the solenoid valve 12 is switched from the air-purging position into the air-supplying position, if the emergency release pressure pSN exceeds the first and/or second threshold value. In this case, the holding valve 14 is de-energized in the open switching position shown in FIG. 2, so that the pilot pressure pSV can be modulated via the emergency release pressure pSN and/or after switching the solenoid valve 12 at the main valve unit 10, so that the main valve unit 10 can consequently modulate the parking brake pressure pBP. The second embodiment (FIG. 2) uses the air-purging path 44 of the solenoid valve 12 in order via this path to input the emergency release pressure, to switch the solenoid valve 12, and in this way to bring about a release of the spring-loaded brake cylinders 108a, 108b.

In order to allow the inputting of the emergency release pressure pSN into the air-purging path 44, which must also be connected to the air-purging 3, the emergency release shuttle valve 42 is also used in this case, as in the first embodiment (FIG. 1). This is arranged in such a way that it allows on the one hand a connection between the pilot control unit 8 and the air-purging 3, but on the other hand also the inputting of the emergency release pressure pSN via the air-purging path 44 to the pilot control unit 8. For this purpose, the emergency release shuttle valve 42 has a first emergency release shuttle valve connection 42.1, which is connected to the emergency release connection 38. It has a second emergency release shuttle valve connection 42.2, which is connected to the air-purging 3, and a third emergency release shuttle valve connection 42.3, which then in turn is connected to the pilot control unit 8, here the third solenoid valve connection 12.3. The emergency release shuttle valve 42 also has a preferred position and is thus preferably configured as a single check valve. To realize the preferred position, a return line 46 is provided, which has the effect that a valve element 48 pneumatically closes the first emergency release shuttle valve connection 42.1. In the basic state and when the pilot control unit 8 is purged of air via the air-purging path 44, the valve element 48 is in this way preloaded and the second and third emergency release shuttle valve connections 42.2, 42.3 are connected. Only when the emergency release pressure pSN is input against the pressureless air-purging path 44 is the valve element 48 lifted from the position shown in FIG. 2 and releases the first emergency release shuttle valve connection 42.1. Apart from this being realized pneumatically via the return 46, this can also be released mechanically via a spring. It is just preferred that, without pressure and in the air-purging mode, the second and third emergency release shuttle valve connections 42.2, 42.3 are connected to each other permanently and unhindered.

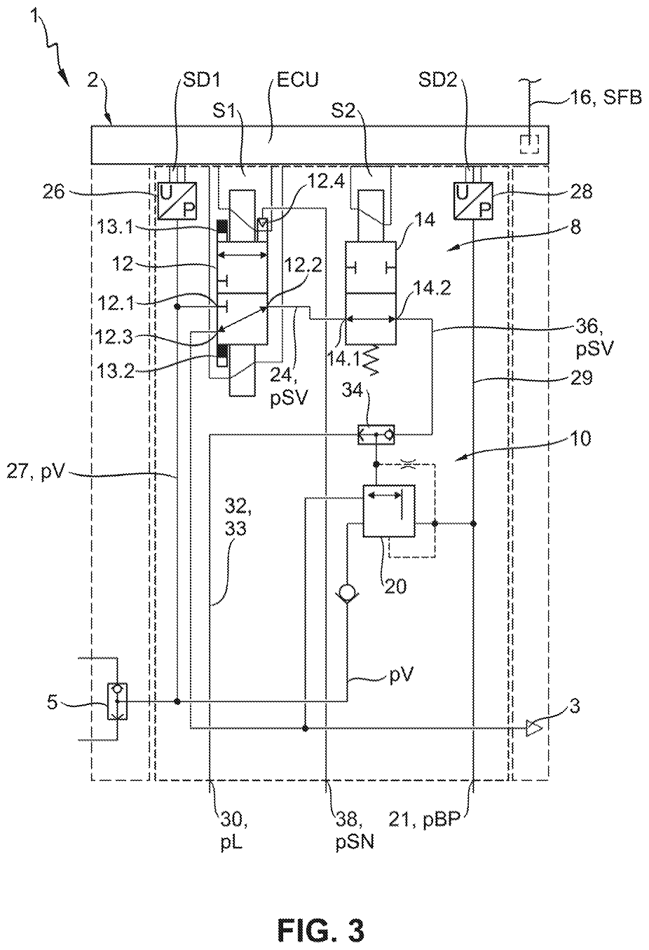

FIG. 3 is again based on FIG. 1, and identical and similar elements are provided with the same reference signs, so that reference is made to the above description of the first embodiment (FIG. 1) in full. In the following, the differences from the first embodiment are highlighted in particular.

The third embodiment according to FIG. 3 differs from the first embodiment substantially in that no self-holding line 22 is provided. In the embodiment shown in FIG. 3, the solenoid valve 12 is also configured without a preferred position and has no spring 18, as in the first embodiment. In order however to switch the solenoid valve 12 in turn from the air-purging position into the air-supplying position in an emergency and without using the first switching signal S1, the solenoid valve 12 has the pneumatic control connection 12.4. Here, the emergency release line 40 is connected to this connection directly, without the intermediate connection of further valves. The self-holding of the solenoid valve 12.4 is realized in this embodiment solely by the first and second permanent magnets 13.1, 13.2. In this respect, the third embodiment is a structurally particularly simple variant.

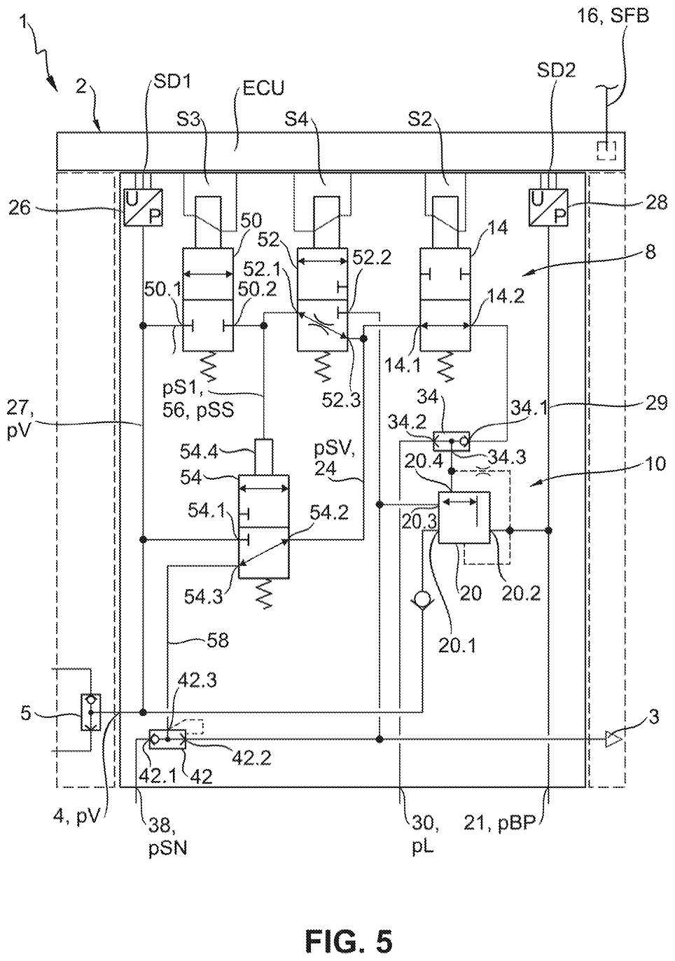

FIGS. 4 and 5 then illustrate two further embodiments of an electropneumatic valve arrangement 1. Identical and similar elements are in turn provided with the same reference signs as in the first two embodiments, so that reference is made to the above description in full. In the following, the differences from the first two embodiments are highlighted in particular.

The essential difference between the first three embodiments (FIG. 1, 2, 3) and the fourth and fifth embodiments (FIG. 4, 5) lies first in the configuration of the pilot control unit 8. In the fourth and fifth embodiments (FIG. 4, 5), the pilot control unit has an inlet valve 50, an outlet valve 52 and a pilot valve 54. Both the inlet valve 50 and the outlet valve 52 are electrically switchable and for this purpose receive a third and a fourth switching signal S3, S4 from the electronic control unit ECU, though these signals S3, S4 can also be provided by a higher-level unit via direct wiring. The inlet valve 50 has a stable switching position shown in FIG. 4 and an activated switching position, not shown in FIG. 4, which it assumes when the third switching signal S3 is provided. In the stable switching position, the inlet valve 50 is closed, in the activated switching position it is open. The inlet valve 50 has a first inlet valve connection 50.1, which is connected to the supply connection 4 and receives supply pressure pV. The inlet valve 50 has a second inlet valve connection 50.2, which is connected to a third control line 56, which in turn is indirectly or directly connected to a pneumatic connection of the pilot valve 54, here more precisely the pneumatic control connection 54.4, which will be described in more detail. In the activated switching position of the inlet valve 50, it modulates a first control pressure pS1 into the third control line 56. For air-purging the third control line 56, and consequently also for air-purging the pneumatic control connection 54.4 of the pilot valve 54, the outlet valve 52 is provided. The outlet valve 52 has a stable switching position shown in FIG. 4 and an activated switching position, not shown in FIG. 4, which it can assume when the fourth switching signal S4 is present. The outlet valve 52 has a first outlet valve connection 52.1, which is connected to the third control line 56, a second outlet valve connection 52.2, which is connected to the air-purging 3, and a third outlet valve connection 52.3, which in the embodiment shown here is connected to the self-holding line 22. The self-holding line 22 in turn branches off from the first control line 24 connected to the first holding valve connection 14.1 and thus provides the pilot pressure pSV as the self-holding pressure pSS at the third outlet valve connection 52.3. Consequently, the outlet valve 52 is de-energized in the stable switching position shown in FIG. 4, in which the pilot pressure pSV is modulated via the outlet valve 52 at the first outlet valve connection 52.1, and consequently in the third control line 56. The third control line 56 can only be purged of air by activating the outlet valve 52.

The pilot valve 54 is purely pneumatically switchable and has no electrical connection, even if in certain embodiments such a connection could be provided. The pilot valve 54 in turn has a stable switching position shown in FIG. 4 and an activated switching position, not shown in FIG. 4. The pilot valve 54 has a first pilot valve connection 54.1, which is connected to the supply connection 4 and receives supply pressure pV. The pilot valve 54 also has a second pilot valve connection 54.2, which is connected to the first control line and modulates the pilot pressure pSV in the activated switching position of the pilot valve 54. A third pilot valve connection 54.3 is connected to the air-purging 3. In the stable switching position of the pilot valve 54, the second pilot valve connection 54.2 is connected to the third pilot valve connection 54.3, so that the first control line 24 is purged of air, and consequently no pilot pressure pSV is modulated at the main valve unit 10 and thus no parking brake pressure pBP at the spring accumulator connection 21 either. Only in the activated switching position of the pilot valve 54 is the first pilot valve connection 54.1 connected to the second pilot valve connection 54.3, so that the pilot pressure pSV is modulated. The pilot valve 54 can be brought into the activated switching position by applying a correspondingly high pressure to the pneumatic control connection 54.4 of the pilot valve 54. For the initial release of the spring-loaded brake cylinders 108a, 108b, this is usually first the first control pressure pS1 modulated via the inlet valve 50. For this purpose, the third switching signal S3 is modulated and the inlet valve 50 is moved into the activated switching position, so that the first control pressure pS1 is modulated. If this exceeds a threshold value, preferably the first threshold value, the pilot valve 54 switches into the activated switching position, not shown in FIG. 4, so that the pilot pressure pSV is modulated. The outlet valve 52 preferably remains in the stable switching position, so that the pilot pressure pSV modulated in the first control line 24 via the self-holding line 22, the third outlet valve connection 52.3, the first outlet valve connection 52.1 and the third control line 56 in turn is modulated at the pneumatic control connection 54.4. If the self-holding pressure pSS in turn exceeds the first threshold value, the pilot valve 54 remains in the activated switching position. In this way, self-holding is implemented. In the outlet valve 52, a restrictor 53 is provided, which acts between the first outlet valve connection 52.1 and the third outlet valve connection 52.3. The pilot pressure pSV can be restricted via the restrictor 53 in order to correspond in particular to the first threshold value.

In the event that, in the case of a fault, the third switching signal S3 cannot be provided, or not correctly, or for example also the outlet valve 52 gets stuck in the activated switching position and thus permanently purges the third control line 56 of air, in the embodiment shown here (FIG. 3) the emergency release pressure pSN can act on the pilot valve 54. For this purpose, the emergency release path 39 is connected to the pilot valve 54, in the embodiment shown in FIG. 4 in particular with the pneumatic control connection 54.4. In order to be able to modulate both the first control pressure pS1 or the self-holding pressure pSS and the emergency release pressure pSN at the pneumatic control connection 54.4, the emergency release shuttle valve 42 is in turn connected in between. The first emergency release shuttle valve connection 42.1 is connected here to the third control line 56 and thus receives the first control pressure pS1 or the self-holding pressure pSS. The second emergency release shuttle valve connection 42.2 is connected to the emergency release connection 38 and receives the emergency release pressure pSN. The third emergency release shuttle valve connection 42.3 is connected to the pneumatic control connection 54.4. The emergency release shuttle valve 42 is in turn configured so that it has a preferred position, to be specific preferably connects the first to the third emergency release shuttle valve connection 42.1, 42.2. Only when the first emergency release shuttle valve connection 42.1 is pressureless or substantially pressureless can the valve element 48 be lifted from the position shown in FIG. 4 by a pressure on the second emergency release shuttle valve connection 42.2, so that the emergency release pressure pSN is modulated at the pneumatic control connection 54.4. In this way, even without the third switching signal S3, the pilot valve 54 can be brought into the activated switching position, so that the pilot pressure pSV is modulated.

In the fourth embodiment, both the emergency release pressure pSN and also the first control pressure pS1 and the self-holding pressure pSS are thus modulated at the pneumatic control connection 544. In other embodiments not shown here, further pneumatic control connections may also be provided. For example, each of the three pressures is provided with its own control connection. Alternatively, two pneumatic control connections are provided, wherein the assignment may be freely selectable here; for example, the emergency release pressure pSN is modulated at the pneumatic control connection 54.4, while the first control pressure pS1 and the self-holding pressure pSN are modulated at a further pneumatic control connection (not shown).

The fourth embodiment (FIG. 5) is based on the third embodiment (FIG. 4) and identical and similar elements are in turn provided with the same reference signs, so that reference is made to the above description in full.

The essential difference between the third and fourth embodiments is that the emergency release pressure pSN is not modulated at the pneumatic control connection 54.4, but at the pilot control unit 8, also at the pilot valve 54, though at an air-purging path 58 of the pilot valve 54. If this is in the stable switching position shown in FIG. 5, the first pilot valve connection 54.1 is connected to the second pilot valve connection 54.2, so that the emergency release pressure pSN can be modulated via the air-purging path 58 of the pilot valve 54 into the first control line 24, and consequently at the main valve unit 10. In this respect, the fourth embodiment is similar to the second embodiment. The emergency release shuttle valve 42 is also configured to match the second embodiment (FIG. 2). Also in this way, the parking brake pressure pBP can thus be modulated if the third and/or fourth switching signal S3, S4 cannot be provided, or not correctly.

Finally, FIG. 6 illustrates a vehicle 100, to be specific a commercial vehicle, with a brake system 102, which is configured here as an electronically controllable pneumatic brake system. The vehicle 100 has a front axle VA and a rear axle HA. A central processing module 104, which is also configured as a rear axle modulator, brakes the rear axle HA, and a front axle modulator 106 is assigned to the front axle VA. The central processing module 104 and the front axle modulator 106 are connected to each other via an electronic line 107 and thus exchange signals, such as in particular brake signals. In addition to first and second spring-loaded brake cylinders 108a, 108b, also provided on the rear axle HA are first and second service brake cylinders 109a, 109b, which can be accommodated together with the spring-loaded brake cylinders 108a, 108b in so-called tristop cylinders. On the front axle VA, the front axle modulator 106 controls corresponding brake pressures at front axle service brake cylinders 110a, 110b. The spring-loaded brake cylinders 108a, 108b are controlled via a parking brake module 2, in which the electropneumatic valve arrangement 1 according to the disclosure is implemented. The parking brake module 2 has the spring accumulator connection 21, which, as shown in FIG. 5, is connected to the spring-loaded brake cylinders 108a, 108b. The vehicle BUS 16 connects the parking brake module 2 to the central processing unit 104.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION

1 Electropneumatic valve arrangement
2 Parking brake module
3 Air-purging
4 Supply connection
5 Supply shuttle valve
6 First compressed air supply
7 Second compressed air supply
8 Pilot control unit
10 Main valve unit
12 Electromagnetic solenoid valve
12.1 First solenoid valve connection
12.2 Second solenoid valve connection
12.3 Third solenoid valve connection
12.4 Pneumatic control connection of the solenoid valve
13.1 First permanent magnet
13.2 Second permanent magnet
13.3 First coil
13.4 Second coil
14 Holding valve
14.1 First holding valve connection
14.2 Second holding valve connection
16 Vehicle BUS
18 Spring
20 Relay valve
20.1 Relay valve supply connection
20.2 Relay valve working connection
20.3 Relay valve air-purging connection
20.4 Relay valve control connection
21 Spring accumulator connection
22 Self-holding line
24 First control line
26 First pressure sensor
27 First pressure measuring line
28 Second pressure sensor
29 Second pressure measuring line
30 Release control connection
32 Release control path
33 Release line
34 Shuttle valve
34.1 First shuttle valve connection
34.2 Second shuttle valve connection
34.3 Third shuttle valve connection
36 Second control line
38 Emergency release connection
39 Emergency release path
40 Emergency release line
42 Emergency release shuttle valve
42.1 First emergency release shuttle valve connection
42.2 Second emergency release shuttle valve connection
42.3 Third emergency release shuttle valve connection
44 Air-purging path
46 Return
48 Valve element
50 Inlet valve
50.1 First inlet valve connection
50.2 Second inlet valve connection
52 Outlet valve
52.1 First outlet valve connection
52.2 Second outlet valve connection
52.3 Third outlet valve connection
53 Restrictor
54 Pilot valve
54.1 First pilot valve connection
54.2 Second pilot valve connection
54.3 Third pilot valve connection
54.4 Pneumatic control connection of the pilot valve
56 Third control line
58 Air-purging path of the pilot valve
100 Commercial vehicle
102 Brake system
104 Central processing module
106 Front axle modulator
108a, 108b Spring-loaded brake cylinder
109a, 109b Service brake cylinder on the rear axle
110a, 110b Service brake cylinder on the front axle
ECU Electronic control unit
pBP Parking brake pressure
pL Release control pressure
pSN Emergency release pressure
pSS Self-holding pressure
pSV Pilot pressure
pV Supply pressure
S1 First switching signal
S2 Second switching signal
SFB Parking brake signal
SD1 First pressure signal
SD2 Second pressure signal
VA Front axle
HA Rear axle

1. An electropneumatic valve arrangement for actuating a parking brake function of an electropneumatic brake system of a commercial vehicle, the electropneumatic valve arrangement comprising:
a pilot control unit configured to modulate a pilot pressure in dependence on an electronic parking brake signal and configured to be self-holding, wherein the pilot pressure is configured to bring about a modulation of a parking brake pressure at least at one spring accumulator connection or is configured to be modulated as such;
said pilot control unit having a pneumatic control connection; and,
an emergency release connection having an emergency release path for optionally inputting an emergency release pressure provided at said pneumatic control connection and being configured to bring about the modulation of the parking brake pressure at said at least one spring accumulator connection.

2. The electropneumatic valve arrangement of claim 1, wherein said pilot control unit is configured to be self-holding in that the pilot pressure modulated by said pilot control unit or a pressure dependent thereon is returned via a self-holding line and is provided as a self-holding pressure at said pneumatic control connection or a further pneumatic control connection associated with said pilot control unit.

3. The electropneumatic valve arrangement of claim 2, wherein, in an event that the pressure applied to at least one of said pneumatic control connection and the further pneumatic control connection is below a first threshold value, said pilot control unit is switched into a stable air-purging position.

4. The electropneumatic valve arrangement of claim 1, wherein the inputting of the emergency release pressure is configured to bring about the modulation of the pilot pressure by said pilot control unit.

5. The electropneumatic valve arrangement of claim 1, wherein the inputting of the emergency release pressure configured to bring about a switching of a valve of said pilot control unit.

6. The electropneumatic valve arrangement of claim 1, wherein said emergency release path enters an air-purging path of said pilot control unit.

7. The electropneumatic valve arrangement of claim 1, wherein said pilot control unit has a self-holding valve unit and a holding valve.

8. The electropneumatic valve arrangement of claim 2, wherein said pilot control unit has an electromagnetic solenoid valve with at least one first permanent magnet; said electromagnetic solenoid valve includes said pneumatic control connection; and, said electromagnetic solenoid valve is configured to switch from an air-purging position into an air-supplying position in dependence upon the emergency release pressure.

9. The electropneumatic valve arrangement of claim 8, wherein said electromagnetic solenoid valve is configured to receive the self-holding pressure at said pneumatic control connection or the further pneumatic control connection; and, said electromagnetic solenoid valve is configured to switch from said air-purging position into said air-supplying position in dependence upon the self-holding pressure.

10. The electropneumatic valve arrangement of claim 8, wherein:
said electromagnetic solenoid valve has a first solenoid valve connection configured to receive a supply pressure, a second solenoid valve connection configured to modulate the pilot pressure, and a third solenoid valve connection connected to an air-purging; wherein, in said air-supplying position of said electromagnetic solenoid valve, said first solenoid valve connection is connected to said second solenoid valve connection and, in said air-purging position of the solenoid valve, said third solenoid valve connection is connected to said second solenoid valve connection; said electromagnetic solenoid valve has a coil; and, by energizing said coil, said electromagnetic solenoid valve is configured to optionally be switched into said air-supplying position or said air-purging position, wherein said electromagnetic solenoid valve is configured to be held magnetically in the corresponding one of said air-supplying position and said air-purging position via said at least one permanent magnet.

11. The electropneumatic valve arrangement of claim 10, wherein, in an event that at least one of the self-holding pressure and the emergency release pressure is below a threshold value, said electromagnetic solenoid valve is switched into said air-purging position independently of a previous switching position.

12. The electropneumatic valve arrangement of claim 10, wherein, in an event that the self-holding pressure exceeds a first threshold value, said electromagnetic solenoid valve is held in a previous switching position.

13. The electropneumatic valve arrangement of claim 12, wherein said electromagnetic solenoid valve, by energizing said coil, is configured to be optionally switched into said air-supplying position or said air-purging position.

14. The electropneumatic valve arrangement of claim 12, wherein, in an event that the self-holding pressure exceeds a second threshold value, which is higher than said first threshold value, said electromagnetic solenoid valve is switched into said air-supplying position.

15. The electropneumatic valve arrangement of claim 14, wherein by energizing said coil said electromagnetic solenoid valve is switchable into said air-purging position.

16. The electropneumatic valve arrangement of claim 8, wherein said electromagnetic solenoid valve has a preferred position.

17. The electropneumatic valve arrangement of claim 16, wherein in said preferred position said pilot control unit is connected to an air-purging.

18. The electropneumatic valve arrangement of claim 9, wherein the emergency release pressure via the emergency release path is connected to said pneumatic control connection of said electromagnetic solenoid valve.

19. The electropneumatic valve arrangement of claim 1, wherein said pilot control unit has an inlet valve and an outlet valve each configured to be switched electrically between a stable state and an activated state; said pilot control unit further has a pilot valve including said pneumatic control connection or a further pneumatic control connection, which receives a supply pressure and switches between a stable state and an activated state in response to a first control pressure, which is provided by at least one of said inlet valve and said outlet valve at the pneumatic control connection; and, said pilot valve is configured to modulate the pilot pressure in said activated state.

20. The electropneumatic valve arrangement of claim 19, wherein said emergency release path for modulating the emergency release pressure is connected to said pilot valve to cause said pilot valve to modulate the pilot pressure.

21. The electropneumatic valve arrangement of claim 19, wherein said emergency release path for modulating the emergency release pressure is connected to said pneumatic control connection or said further pneumatic control connection of said pilot valve.

22. The electropneumatic valve arrangement of claim 19, wherein said emergency release path enters an air-purging path of said pilot valve.

23. The electropneumatic valve arrangement of claim 3, wherein the first threshold value lies in a range of at least one of 200 kPa to 400 kPa and 250 kPa to 350 kPa.

24. The electropneumatic valve arrangement of claim 11, wherein the first threshold value lies in a range of at least one of 200 kPa to 400 kPa and 250 kPa to 350 kPa.

25. The electropneumatic valve arrangement of claim 12, wherein the first threshold value lies in a range of at least one of 200 kPa to 400 kPa and 250 kPa to 350 kPa.

26. The electropneumatic valve arrangement of claim 14, wherein said second threshold value lies in a range of at least one of 500 kPa to 900 kPa and 600 kPa to 800 kPa.

27. The electropneumatic valve arrangement of claim 1 further comprising a main valve unit configured to receive the pilot pressure and modulate the parking brake pressure at the at least one spring accumulator connection in dependence upon the pilot pressure.

28. A method for controlling a parking brake function of a commercial vehicle having an electropneumatic brake system, the method comprising:
electromagnetically switching at least one valve of a pilot control unit into an air-supplying position for modulating a pilot pressure and, as a consequence: modulating a parking brake pressure at least at one spring accumulator connection for supplying air to at least one spring-loaded brake cylinder;
at least one of confining the modulated pilot pressure and holding the at least one valve in an air-purging position;
air-purging the pilot pressure when a supply pressure provided to the pilot control unit drops below a first threshold value; and,
inputting an emergency release pressure at an emergency release connection to bring about the modulation of the parking brake pressure for releasing the at least one spring-loaded brake cylinder.

29. The method of claim 28, wherein said inputting of the emergency release pressure brings about the switching of a valve of the pilot control unit.

30. The method of claim 28, wherein said inputting of the emergency release pressure brings about the modulation of the pilot pressure by the pilot control unit.

31. The method of claim 28 further comprising modulating a self-holding pressure at a pneumatic control connection assigned to the pilot control unit for self-holding the pilot control unit in an air-supplying position, so that the pilot pressure remains modulated independently of electrical signals.

32. A method for controlling a parking brake function of a commercial vehicle having an electropneumatic brake system and an electropneumatic valve arrangement for actuating a parking brake function of the electropneumatic brake system, the electropneumatic valve arrangement including a pilot control unit and an emergency release connection, the pilot control unit being configured to modulate a pilot pressure in dependence on an electronic parking brake signal and being configured to be self-holding, wherein the pilot pressure is configured to bring about a modulation of a parking brake pressure at least at one spring accumulator connection or is configured to be modulated as such, the pilot control unit having a pneumatic control connection, the emergency release connection having an emergency release path for optionally inputting an emergency release pressure provided at said pneumatic control connection and being configured to bring about the modulation of the parking brake pressure at said at least one spring accumulator connection, the method comprising:
electromagnetically switching at least one valve of the pilot control unit into an air-supplying position for modulating the pilot pressure and, as a consequence: modulating the parking brake pressure at least at one spring accumulator connection for supplying air to at least one spring-loaded brake cylinder;
at least one of confining the modulated pilot pressure and holding the at least one valve in the air-purging position; and,
air-purging the pilot pressure when the supply pressure provided to the pilot control unit drops below a first threshold value; and,
inputting an emergency release pressure at the emergency release connection to bring about the modulation of the parking brake pressure for releasing the at least one spring-loaded brake cylinder.

33. A commercial vehicle comprising an electronically controllable pneumatic brake system having the electropneumatic valve arrangement of claim 1.
